(19) United States
(12) Patent Application Publication
(10) Pub. No.: US 2013/0050388 A1
(43) Pub. Date: Feb. 28, 2013

(54) IMAGE FORMING APPARATUS

(71) Applicant: Kazuyuki Ohnishi, Nara (JP)

(72) Inventor: Kazuyuki Ohnishi, Nara (JP)

(73) Assignee: Sharp Kabushiki Kaisha, Osaka (JP)

(21) Appl. No.: 13/594,152

(22) Filed: Aug. 24, 2012

(30) Foreign Application Priority Data
Aug. 26, 2011 (JP) JP 2011-184584

(51) Int. Cl. B41J 2/435

(52) U.S. Cl. 347/224

(57) ABSTRACT

An image forming apparatus includes a pulse width modulation unit that changes pulse width of a signal in accordance with image data, and an image forming unit that forms an image by a driving laser beam with a signal whose pulse width has been modulated by the pulse width modulation unit and scanning a photosensitive body, and corrects the pulse width of the signal output by the pulse width modulation unit in accordance with a density unevenness characteristics in the main scanning direction of the image forming unit.

### CROSS-REFERENCE TO RELATED APPLICATION

This application claims priority under 35 U.S.C. §119(a) on Patent Application No. 2011-184584 filed in Japan on Aug. 26, 2011, the entire contents of which are herein incorporated by reference.

### BACKGROUND OF THE INVENTION

1. Field of the Invention

The present invention relates to an image forming apparatus that performs printing by a laser beam, and more specifically relates to an image forming apparatus that can correct unevenness in the print density caused by unevenness in the main scanning direction of, for example, sensitivity of a photosensitive body and the like.

2. Description of the Related Art

Generally, in an image forming apparatus, density unevenness in the main scanning direction is produced by unevenness of the sensitivity of a photosensitive body with respect to a laser beam, transfer irregularities when transferring toner from a photosensitive body to a transfer belt, and transfer irregularities when transferring toner from a photosensitive body to a paper sheet, or the like.

As one example of methods for correcting this, a method in which the light amount of a laser beam is corrected has been put to practice.

In this method, a density unevenness in the main scanning direction is measured in advance, the amount of correction is determined based on a result of the measurement, and the value of a current that drives a laser is corrected in accordance with the timing of printing in the main scanning direction.

Driving of a laser is usually performed with a laser driver IC (integrated circuit). The laser driver IC (hereinafter, simply referred to as “laser driver”) is often not incorporated into an LSI (large-scale integrated circuit) such as an image processing circuit or the like, since it is necessary to control the driving current in an analog manner with a power supply of about 5V, and is often independent of other control circuits.

Also, with an ordinary laser driver, since the laser light amount is controlled so as to take on a given value, a method is ordinarily used in which if an image that has a gradation is formed, then the exposure time per pixel of the photosensitive body is changed by changing the on/off ratio of the laser in the time for one pixel by PWM (pulse width modulation), and thereby the amount of toner affixed to the photosensitive body is changed so that light and dark tones are expressed in the image.

Also, JP 2006-53240A (hereinafter, referred to as Patent Document 1) discloses a technology in which formation of line unevenness in the main scanning direction is avoided by changing the pulse width of a pulse signal that modulates a laser beam according to image density, and extending the modulated laser beam in the sub-scanning direction by a cylindrical lens.

With an ordinary laser driver, although the laser light amount is controlled to a given beam amount serving as a target value, as described above, if the density unevenness is corrected with the laser light amount, a laser driver is needed that divides the laser light amount into multiple areas along the main scanning direction and that can change the driving current individually for each area.

Also, it is desirable that the laser driver is disposed in the vicinity of a laser diode in a laser scanning unit (LSU). Also, while it is necessary to control the current of the laser diode with the power supply of 5V, since recent digital image processing ICs have lower voltages, the laser driver is often provided independently of these ICs.

Accordingly, it is necessary to receive from image processing circuit (image processing IC) or the like the information which area the laser beam is scanning in the main scanning direction, and it is necessary for the laser driver to switch the current for driving the laser in response to that, and thus the circuit scale of the laser driver or the image processing circuit increases.

Also, the method described in Patent Document 1 is a method in which the line unevenness in the main scanning direction is avoided, but the sensitivity unevenness of a photosensitive body that exists depending on the location in the main scanning direction and the density unevenness in an image due to the transfer irregularities of toner transferred to a paper sheet are not solved.

The present invention was made in view of such circumstances, and it is an object thereof to provide an image forming apparatus that can correct density unevenness in the main scanning direction by correcting the pulse width for driving a laser beam in accordance with the density unevenness in the main scanning direction.

### SUMMARY OF THE INVENTION

In order to solve the above-described issues, the image forming apparatus of the present invention includes a pulse width modulation unit that changes a pulse width of a signal in accordance with image data and an image forming unit that forms an image by driving a laser beam with a signal whose pulse width has been modulated by the pulse width modulation unit and scanning a photosensitive body wherein the pulse width of the signal output by the pulse width modulation unit is corrected in accordance with a density unevenness characteristics in a main scanning direction of the image forming unit.

According to such a configuration, since the sensitivity characteristics of the photosensitive body or the like for the laser beam in the main scanning direction can be corrected using a circuit that used in printing, it is not necessary to add a new circuit for correction and it is possible to constitute the circuit easily.

Also, according to the image forming apparatus of the present invention, the pulse width modulation unit may be configured to synchronize data that indicates an amount of correction according to the density unevenness characteristics in the main scanning direction with the image data, and receives that data along with the image data.

According to such a configuration, since it is possible to treat the data that indicates the amount of correction as data that is identical to the image data (to treat the data indicating the amount of correction and the image data as a single set of data), it is possible to constitute the circuit easily.

Also, according to the image forming apparatus of the present invention, the correction of the pulse width by the pulse width modulation unit may be performed by changing the pulse width toward both sides in the main scanning direction from a center of a pixel.

According to such a configuration, even if the pulse width is changed, since a position of the center of a pixel does not change, there are no changes in the substantial center of the pixel, and thus the image quality does not decrease.

Also, according to the image forming apparatus of the present invention, the correction amount of the pulse width by the pulse width modulation unit may be determined based on a result obtained by measuring a density of the image formed by the image forming unit.

According to such a configuration, by determining the correction amount by measuring change in the density unevenness with the density sensors of a process controller or the like, it is possible to handle the case that the density unevenness in the main scanning direction changes over time.

Also, according to the image forming apparatus of the present invention, the correction amount of the pulse width may be determined based on a first correction coefficient for each position in the main scanning direction that is determined in advance based on a value that has been measured under a given image formation condition and output by a density detection unit.

According to such a configuration, by determining the correction amount based on a first correction coefficient for the position in the main scanning direction that is determined in advance based on a measurement value determined by measuring change in the density unevenness in the main scanning direction with a density detection unit of the process controller, it is also possible to handle the case that the density unevenness in the main scanning direction changes over time.

Also, according to the image forming apparatus of the present invention, the correction amount of the pulse width may be determined by a status of a plurality of pixels surrounding a target pixel in the image data.

According to such a configuration, depending on density of pixels to be formed, even if the relationship between the pulse width and the image density is non-linear, it is possible to accurately correct density unevenness.

Also, according to the image forming apparatus of the present invention, the correction amount of the pulse width of the target pixel may be determined based on a value found by determining a first correction coefficient corresponding to the position of the target pixel based on the first correction coefficient for each position in the main scanning direction that is determined in advance based on a value that has been measured under a given image formation condition and output by a density detection unit, determining a second correction coefficient based on a result obtained by multiplying a density value each corresponding to the plurality of surrounding pixels except for the target pixel with a correction coefficient set in advance and adding the multiplied values, and multiplying the first correction coefficient corresponding to the position of the target pixel with the second correction coefficient.

According to such a configuration, depending on the density of pixels to be formed, even if the relationship between the pulse width and the image density is non-linear, it is possible to accurately correct density unevenness.

### BRIEF DESCRIPTION OF THE DRAWINGS

FIG. 1 is a diagram of an overall configuration of an image forming apparatus of the present invention applied to a copier.

FIG. 2 is a schematic block diagram showing an electrical configuration of main portions of the copier according to one embodiment of the present invention.

FIG. 3A is a diagram schematically showing an image that is to be printed.

FIG. 3B is a diagram schematically showing an image if the image shown in FIG. 3A is printed without correction.

FIG. 3C is a diagram showing the form of pulse signals in portions in the main scanning direction if the image shown in FIG. 3A is printed without correction (if printing is performed as shown in FIG. 3B).

FIG. 3D is a diagram schematically showing an image if the image shown in FIG. 3A is printed with correction.

FIG. 3E is a diagram showing the form of pulse signals in portions in the main scanning direction if the image shown in FIG. 3A is printed with correction (if printing is performed as shown in FIG. 3D).

FIG. 4 is a block diagram showing in detail a pulse width modulation unit of a copier according to one embodiment of the present invention.

FIG. 5A is an illustrative diagram showing, as a graph, an example of setting values for a LUT used in the pulse width modulation unit shown in FIG. 4.

FIG. 5B is an illustrative diagram showing, in form of a table, an example of setting values for a LUT used in the pulse width modulation unit shown in FIG. 4.

FIG. 6A is an illustrative diagram showing details of the position of dots formed by a pulse signal P1 shown in FIG. 3C and a pulse signal P11 shown in FIG. 3E.

FIG. 6B is an illustrative diagram showing details of the position of dots formed by the pulse signal P1 shown in FIG. 3C and the pulse signal P11 shown in FIG. 3E.

FIG. 6C is an illustrative diagram schematically showing a toner pattern formed with a method shown in FIG. 6A.

FIG. 6D is an illustrative diagram schematically showing a toner pattern formed with a method shown in FIG. 6B.

FIG. 7A is a diagram illustrating a method for calculating density correction data in a density correction value generation unit, and is an illustrative diagram showing an example of a ratio of surrounding pixels to a target pixel.

FIG. 7B is a diagram illustrating a method for calculating density correction data in the density correction value generation unit, and is a graph showing an example of a correction coefficient (second correction coefficient) set in advance based on a result of addition.

FIG. 7C is a diagram illustrating a method for calculating density correction data that is sent from the density correction value generation unit, and is a graph showing an example of a correction coefficient (first correction coefficient) found from values output by a density sensor that have been measured in advance under a given image formation condition.

### DESCRIPTION OF THE PREFERRED EMBODIMENT

Hereinafter, an embodiment of the present invention will be described with reference to the drawings.

In the following description, a case is described in which an image forming apparatus of the present invention is applied to a copier.

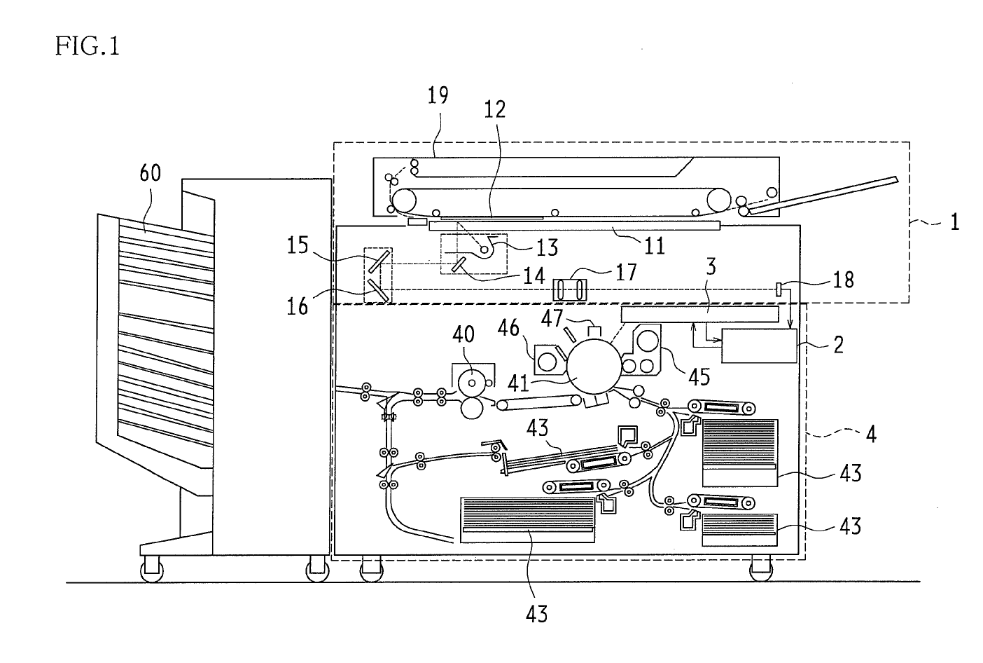

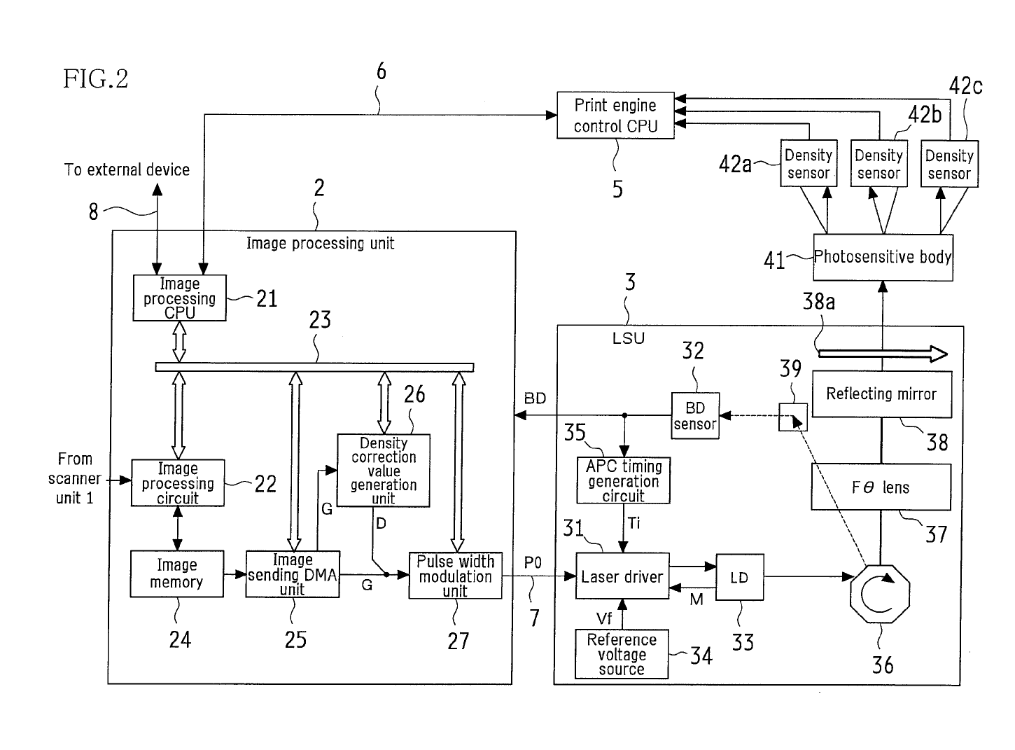

FIG. 1 is a diagram of an overall configuration of the copier according to one embodiment of the present invention, and FIG. 2 is a schematic block diagram showing the electrical configuration of main portions of the copier according to one embodiment of the present invention and shows a state in which a laser scanning unit is connected to an image processing unit.

As shown in FIG. 1, a scanner unit 1 reads an image of an original 12 placed on an original placement stage 11 formed of hard transparent glass with a CCD sensor 18 via a lamp unit 13, mirrors 14 to 16, and a lens unit 17, and transmits the read image data to an image processing unit 2. Although the original 12 is read in a state of being placed on the original placement stage 11 in FIG. 1, the configuration may also be such that the original 12 is read while being fed by a document feeder unit 19 provided in the scanner unit 1.

The image processing unit 2 converts image data obtained from the scanner unit 1 into a form that is suitable to be printed by performing dither processing or the like, and receives print data from a personal computer or the like that is not shown and generates image data for printing.

A print engine (image forming unit) 4 causes a laser of a laser scanning unit (LSU) 3 to emit light in accordance with the image data from the image processing unit 2, forms an electrostatic latent image by exposing a photosensitive body 41 to this light, and forms a visible image by affixing toner with a development unit 45. The formed visible image is transferred to a paper sheet supplied from any of various paper cassettes 43 that can store paper sheets of various sizes, and fixed by a fixing unit 40 and discharged on a discharge tray 60.

As shown in FIG. 2, a print engine control CPU (process controller) 5 that controls the print engine 4 is bi-directionally connected to an image processing CPU 21 of the image processing unit 2 via a communication line 6. Moreover, upon receiving a request from the image processing unit 2 to start printing, the print engine control CPU 5 performs processing for cleaning a surface of the photosensitive body 41 with a cleaning unit 46, charging the photosensitive body 41 with a charger 47, and feeding paper from the paper cassette 43, and when it becomes possible to start printing, the print engine control CPU 5 sends a notification that it is possible to print to the image processing CPU 21 of the image processing unit 2.

A synchronization signal BD that indicates the timing for starting to transfer an image is output from the LSU 3 to the image processing unit 2. The image processing unit 2 converts the image data to on/off signals of the laser in response to this synchronization signal BD, and transfers these on/off signals to a laser driver 31 of the LSU 3 through a pulse signal transfer line 7.

The image processing CPU 21 is bi-directionally connected not only to the print engine control CPU 5, but also an external device, such as a PC (personal computer) or the like that is not shown via a communication line 8, and gives an instruction for generating and transmitting the image data, or the like while communicating with this external device.

An image processing circuit 22 is controlled by the image processing CPU 21 through a bus 23, and receives the image data from the scanner unit 1 and print image data deployed by the image processing CPU 21, and performs necessary processing on the data and stores the data in an image memory 24.

An image sending DMA unit 25 reads out the image data stored in the image memory 24, synchronizes the read out data with the synchronization signal BD (synchronization signal BD indicating timing for starting to transfer image) transmitted from a BD sensor 32 of the LSU 3, and sends image data G to a density correction value generation unit 26 and a pulse width modulation unit 27 (more specifically, starts to send image data for one line along the main scanning direction). It should be noted that the image sending DMA unit 25 sends the image data G for one line sequentially pixel by pixel along the main scanning direction to the density correction value generation unit 26 and the pulse width modulation unit 27 a plurality of times.

The density correction value generation unit 26 is configured to receive the image data G sent from the image sending DMA unit 25 and output data D (hereinafter, also referred to as density correction data) on a correction value (density correction value) set in advance, to the pulse width modulation unit 27, depending on which position in the main scanning direction the image data G that is output by the image transmit DMA unit 25 corresponds to.

Also, the density correction value generation unit 26 is configured to receive the image data G sent from the image sending DMA unit 25 and output the density correction data D depending on the data on one pixel (target pixel) among the image data G and data on the surrounding pixels. Specifically, the density correction value generation unit 26 sends the density correction data D related to printing of the target pixel to the pulse width modulation unit 27 depending on a position of the target pixel in the main scanning direction as indicated by the image data G and the density values of the multiple surrounding pixels of the target pixel. The timing at which the density correction value generation unit 26 sends the density correction data D on the target pixel to the pulse width modulation unit 27 is synchronized with the timing at which the image sending DMA unit 25 sends the image data G on the target pixel.

The pulse width modulation unit 27 receives the density correction data D generated by the density correction value generation unit 26 in synchronization with the image data G sent from the image sending DMA unit 25. Then, the pulse width modulation unit 27 outputs a pulse signal P0 corresponding to the image data G and the density correction data D to the laser driver 31 of the LSU 3 through the pulse signal transfer line 7. With such a configuration, since the pulse width modulation unit 27 is able to handle the density correction data D and the image data G as a single set of data, it is possible to simplify the circuit configuration.

The laser driver 31 controls the current for a laser diode (hereinafter, simply referred to as “LD”) 33 in accordance with the received pulse signal P0, and causes LD 33 to emit light. At this time, the laser driver 31 controls a current value that flows through the LD 33 by a voltage value Vf that is output by a reference voltage source 34, and thereby the light emission amount of the laser is controlled.

Although not shown in the drawings, the LD 33 is configured to be provided with a photodiode on a side opposite to the light emitting surface and is thus capable of monitoring the light emission amount. A monitor signal M for monitoring the light emission amount is input into the laser driver 31.

An APC timing generation circuit 35 that generates a light amount control timing signal for controlling the light amount of the LD 33, and if an APC timing signal Ti output by the APC timing generation circuit 35 is input to the laser driver 31, the laser driver 31 holds the LD 33 in an ON state, controls the current value supplied to the LD 33 so that the monitor signal M matches the reference voltage value Vf, and stores the control amount.

The laser beam emitted from the LD 33 is reflected and scanned by a polygon mirror 36, and the surface of the photosensitive body 41 is exposed to the emitted laser beam via an fθ lens 37 and a reflecting mirror 38. A BD sensor mirror 39 is provided on a starting side 38a (left hand side of white arrow in FIG. 2) in the main scanning direction, and reflected light enters the BD sensor 32 through the BD sensor mirror 39 and undergoes photoelectric conversion, and is then output as the synchronization signal BD to the image processing unit 2.

The image sending DMA unit 25 starts to send image data for one line along the main scanning direction in synchronization with the synchronization signal BD.

Meanwhile, the photosensitive body 41 is provided with a plurality of (three in this example) reflective density sensors (density detection units) 42a through 42c for measuring toner density on the photosensitive body, which are lined up next to the photosensitive body 41 along the main scanning direction, and thus the print engine control CPU 5 is able to read the density values.

The print engine control CPU 5 is configured to be able to read the density of a toner image generated under a given image formation condition with the density sensors 42a through 42c, detect any density unevenness (density unevenness characteristics) in the main scanning direction from the read values, calculate a necessary correction value, and set the correction values for various positions in the main scanning direction in the density correction value generation unit 26 via the image processing CPU 21. It should be noted that “density unevenness in the main scanning direction (density unevenness characteristics)” refers to the density characteristics for each position along the main scanning direction.

Here, “a given image formation condition” refers, specifically, to a condition in which a charge voltage value for the charger 47 that charges the photosensitive body 41, and a development bias voltage value applied to the development unit 45 are set to the values determined in advance, and an image is formed under the condition, and these values may be set appropriately.

The following is an explanation of processing for correcting the density unevenness in the main scanning direction by correcting the pulse width for driving the laser beam according to the density unevenness in the main scanning direction in the copier with the above-described configurations.

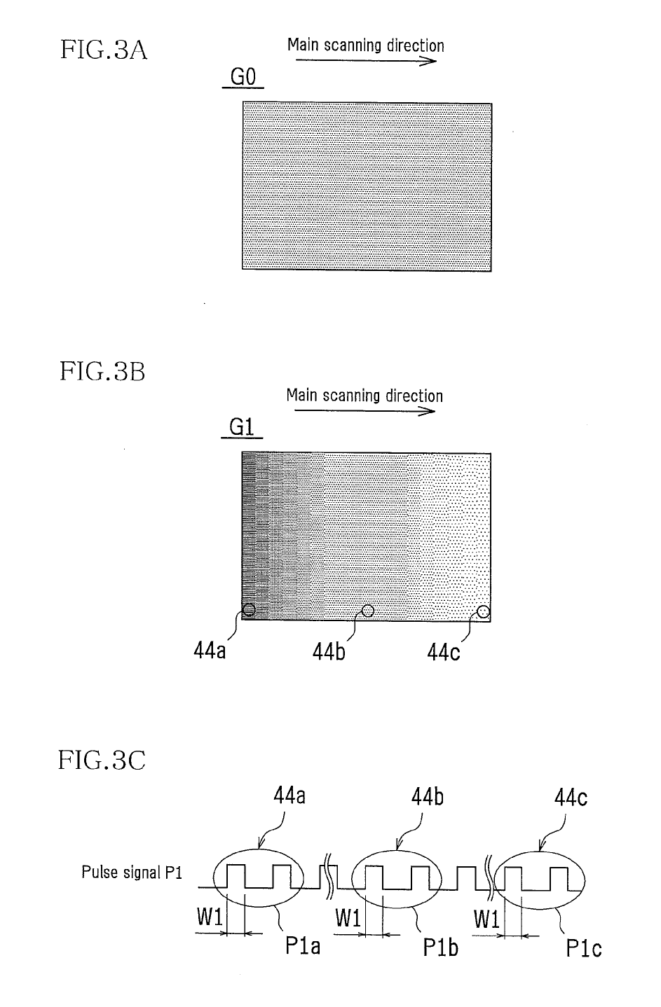

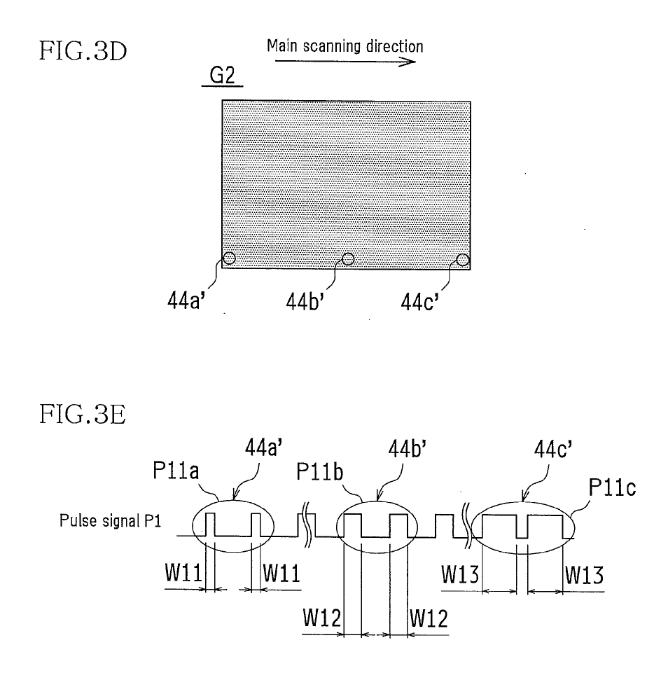

FIGS. 3A through 3E schematically shows examples of images and pulse signals that are generated in cases where an image in which there is a density unevenness in the main scanning direction is printed even if an image with uniform density was supposed to be printed, and in cases where the pulse width is corrected by the pulse width modulation unit 27.

FIG. 3A shows an image G0 that is to be printed, and the density of this image G0 is uniform in the main scanning direction.

FIG. 3B is an example of an image G1 where the image G0 shown in FIG. 3A is printed without correction, where the density of a writing start side 44a of the main scan is high, the density in a center region 44b is substantially the same as the density of the image G0 shown in FIG. 3A, and the density of a writing end side 44c of the main scan is low.

FIG. 3C shows a pulse signal P1 for the regions 44a through 44c when the image G1 in FIG. 3B is printed (when the image G0 shown in FIG. 3A is printed without correction). All of the pulse widths for the pulse signals P1a, P1b, and P1c, which respectively correspond to the regions 44a through 44c, have the same width W1.

On the other hand, FIG. 3D is an example of an image G2 that has been printed after applying a correction as shown in FIG. 3E to the pulse width as shown in FIG. 3B, and in the image G2, the pulse widths are corrected such that the density of the regions 44a′ through 44c′ is uniform in the main scanning direction.

FIG. 3E shows a pulse signal P11 for the regions 44a′ through 44c′ for printing the image in FIG. 3D (when the image G0 shown in FIG. 3A is corrected and printed). In a pulse signal P11a corresponding to a writing start side 44a′ of the main scan, a pulse width W11 is shorter than the pulse width W1 of the writing start side 44a shown in FIG. 3C (W11<W1), and the printing density of the regions 44a′ of the image G2 shown in FIG. 3D is weaker than the printing density of the regions 44a of the image G1 shown in FIG. 3B. On the other hand, in a pulse signal P11c corresponding to a writing end side 44c′ of the main scan, a pulse width W13 is longer than the pulse width W1 of the writing end side 44c shown in FIG. 3C (W13>W1), and the printing density of the regions 44a′ of the image G2 shown in FIG. 3D is stronger than the printing density of the regions 44c shown in FIG. 3B. Also, since a center portion 44b′ is in a state of the center portion 44b of the image G1 shown in FIG. 3B and is close to an original density value (density of original image G0), no correction is applied to the center portion 44b′. In other words, the pulse width W12 of the pulse signal P11b corresponding to the center portion 44b′ is equal to the pulse width W1 of the pulse signal P1b corresponding to the center portion 44b shown in FIG. 3C (W12=W1).

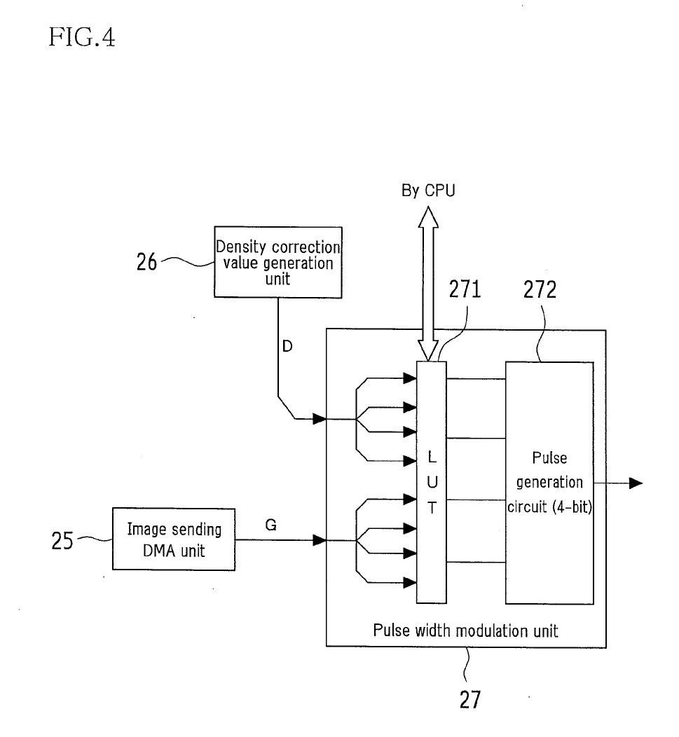

FIG. 4 shows the pulse width modulation unit 27 in detail.

The image data G sent from the image sending DMA unit 25 (image data G for one pixel) is configured by 4 bits. Similarly, the density correction data D sent from the density correction value generation unit 26 is configured by 4 bits. Both the image data G and the density correction data D are input into a conversion lookup table (LUT) 271. The LUT 271 is a RAM that is configured by 1024 bits with 8-bit address and 4-bit data, and has a configuration in which the density correction data D and the image data G are input into the address, and the data of the address specified by these is input to a 4-bit pulse generation circuit 272.

A value in the LUT 271 is initialized by the image processing CPU 21 when the power is turned on. Also, the density correction data D is input into the most significant 4 bits and the image data G is input into the least significant 4 bits of the address.

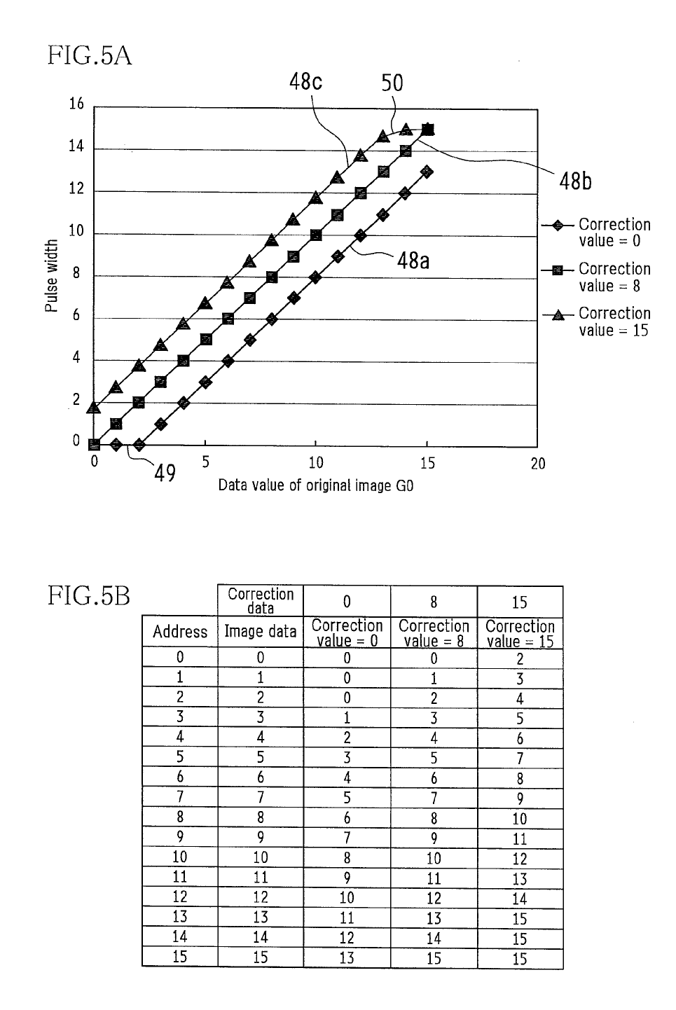

FIGS. 5A and 5B show examples of the setting values in the LUT 271, where FIG. 5A shows them as a graph and FIG. 5B shows them as a list. It should be noted that the setting values in the LUT 271 shown in FIGS. 5A and 5B correspond to setting values for a case where the pulse signal P11 (P11a, P11b, and P11c) shown in FIG. 3E is output to print the image G2 shown in FIG. 3D.

The horizontal axis in FIG. 5A indicates the data values of the original image G0 (density values expressed by 4-bit 16 gradation (0 to 15)), and the vertical axis indicates the pulse widths to be generated (pulse widths corresponding to the density values expressed by 4-bit 16 gradations (0 to 15)), and as the data value increases, the pulse width widens and the image density increases.

With the setting values indicated by a graph 48a in FIG. 5A (the column in FIG. 5B where correction data (density correction data)=0), the pulse width is controlled such that the density is overall lower than the density of the original image, and at a low density portion 49, the pulse width reaches zero, and no pulse signal is output.

Also, with the setting values indicated by a graph 48b in FIG. 5A (the column in FIG. 5B where correction data (density correction data)=8), the density of the original image is not corrected, since the pulse is output with the density of the original image without correction.

Also, with the setting values indicated by a graph 48c in FIG. 5A (the column in FIG. 5B where correction data (density correction data)=15), the pulse width is controlled such that the density is overall higher than the density of the original image, and at a high density portion 50, the pulse width is fixed to the maximum pulse width (maximum pulse width corresponding to a maximum density value 15).

Here, the setting values indicated in FIGS. 5A and 5B, as mentioned above, correspond to FIGS. 3D and 3E, and the setting values of the graph 48a correspond to setting values for controlling the pulse signal P11a (pulse signal P11a corresponding to writing start side 44′ of the main scan) in FIG. 3E, the setting values of the graph 48b correspond to the setting values for controlling the pulse signal P11b (pulse signal P11b corresponding to center portion 44b′) in FIG. 3E, and the setting values of the graph 48c correspond to the setting values for controlling the pulse signal P11c (pulse signal P11c corresponding to the writing end side 44c′ of the main scan) in FIG. 3E.

In the present embodiment, since the pulse width modulation unit 27 is configured to expand a portion that receives the image data G from the image sending DMA unit 25 from 4 bits to 8 bits, and input the density correction data D to the expanded 4 bits, and the density correction value generation unit 26 is configured to output the density correction data D in accordance with a printing position in the main scanning direction, it is possible to incorporate a function of density correction with comparative ease by merely expanding a memory configuration of the conversion LUT 271 in the pulse width modulation unit 27. In other words, since the sensitivity characteristics of the photosensitive body 41 with respect to the laser light in the main scanning direction can be corrected using a circuit used in printing, it is not necessary to add a new circuit for correction.

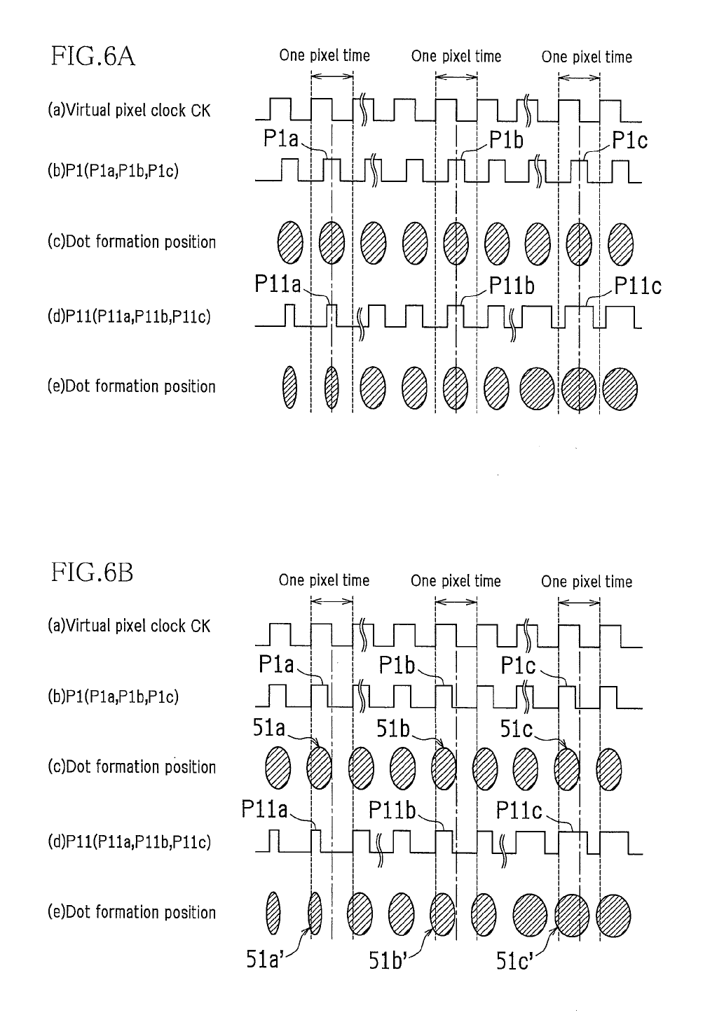

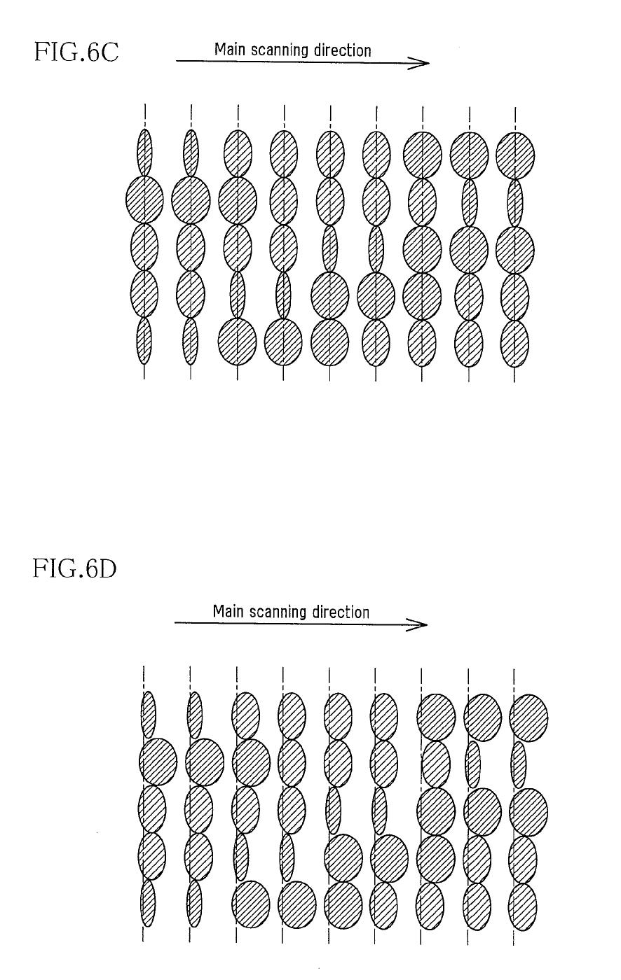

FIGS. 6A and 6B show, in detail, positions of dots formed by the pulse signal P1 (P1a, P1b, and P1c) shown in FIG. 3C and by the pulse signal P11 (P11a, P11b, and P11c) shown in FIG. 3E.

In FIG. 6A, (a) is a virtual pixel clock CK, and (b) and (c) schematically show the generation of the pulse signal P1 according to the present embodiment and the appearance of the formed toner dots, and (d) and (e) schematically show the generation of the pulse signal P11 according to the present embodiment and the appearance of the formed toner dots.

The virtual pixel clock CK shown in (a) indicates the timing for printing one pixel although the clock is not actually output from the pulse width modulation unit 27 as a signal. The time from a rising edge to a subsequent rising edge is the time for one pixel.

In the present embodiment, positions of toner dots formed by pulses of the pulse signal P1 (P1a, P1b, and P1c) shown in (b) are formed in center portions of the virtual pixel clock CK (that is, formed on both sides in the main scanning direction from the center of the pixel), as schematically shown with oblique lines in (c).

This is the same as in the case where the pulse width changes by applying a correction, in other words, in toner dot formation by pulses of the pulse signal P11 (P11a, P11b, and P11c) shown in (d), and as shown in (e), the pulse width for the pulse signals P11a, P11b, and P11c increases/decreases toward the left and right in FIG. 6A, with the falling flanks of the virtual pixel clock CK at the center (on both sides in the main scanning direction from the pixel center), and toner dots that are to be formed are also formed such that the centers of the toner dots are at the same center position as in the case of the toner dots shown in (c).

In contrast, FIG. 6B is an example for a case where a pulse is generated by taking a rising flank (starting position of one pixel) of the virtual pixel clock CK as a reference, where (a) shows a virtual pixel clock CK, (b) and (c) schematically show the generation of the pulse signal P1 and the appearance for the formed toner dots, and (d) and (e) schematically show the generation of the pulse signal P11 and the appearance for the formed toner dots.

In this case, in portions 51a, 51b, and 51c shown in (c), and portions 51a′, 51b′, and 51c′ shown in (e), since pulses (P1a, P1b, P1c, P11a, P11b, and P11c) are generated by taking a rising flank of the virtual pixel clock CK as the reference, as shown FIG. 6B (c) and (e), the center positions of the toner dots move depending on whether they are corrected or not.

It should be noted that FIG. 6C schematically shows a toner pattern (toner pattern for the case where toner dots are formed by increasing/decreasing their pulse width around the falling flanks of virtual pixel clock CK (that is, toward both sides in the main scanning direction from the pixel center)) formed by the method shown in FIG. 6A, and FIG. 6D schematically shows a toner pattern (toner pattern for the case where pulses are generated by taking the rising flanks of the virtual pixel clock CK as a reference, and toner dots are formed) formed by the method shown in FIG. 6B.

In the toner pattern shown in FIG. 6C, even if the size of a dot is changed by correcting density unevenness, the center of each dot does not change, and thus the pattern formation of screen printing or the like is not disturbed and the influence on image quality is suppressed. On the other hand, in the toner pattern shown in FIG. 6D, the center position of each dot is shifted by correcting density unevenness, and thus the image quality is affected.

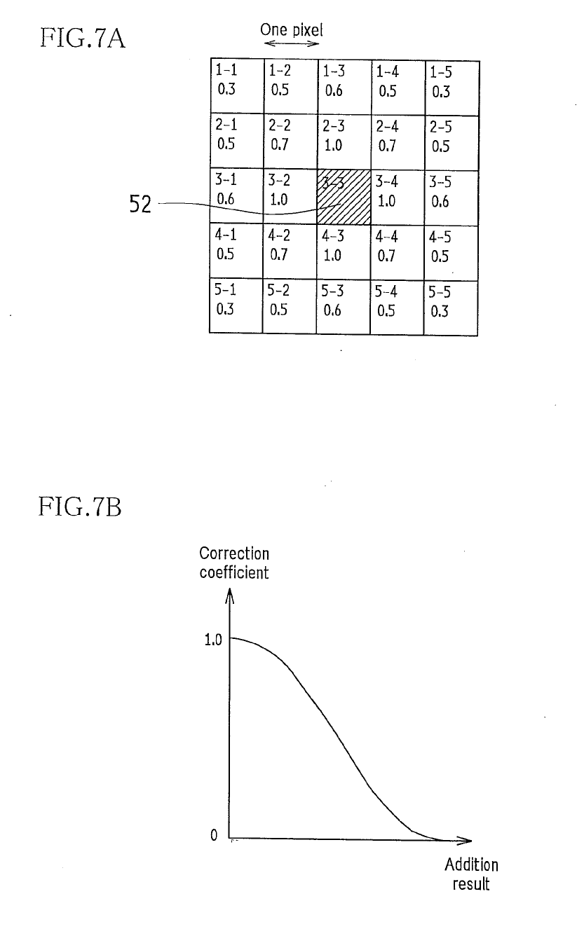

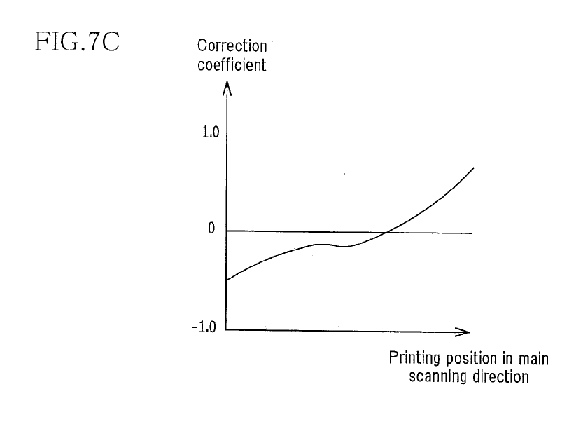

FIGS. 7A through 7C show an example for a method for calculating the density correction data for the case where the density correction value generation unit 26 is configured such that density correction data D is output taking a target pixel 52 (indicated by oblique lines in FIG. 7A) to be printed and its surrounding pixels (the state of the pixels surrounding the target pixel) into consideration.

The density correction value generation unit 26 includes a plurality of line memories for storing the image data G of lines along the main scanning direction. The density correction value generation unit 26 stores the image data G sent from the image sending DMA unit 25 pixel by pixel for each line along the main scanning direction in the line memories.

Also, when receiving the image data G for one pixel from the image sending DMA unit 25, the density correction value generation unit 26 takes a pixel received three lines prior to (three lines prior along the sub-scanning direction) the pixel corresponding to the received image data G as a target pixel. Then, the density correction data D for this target pixel is determined, and the determined density correction data D is sent with the timing at which the image sending DMA unit 25 sends the image data G for the target pixel to the pulse width modulation unit 27.

Hereinafter, a method for calculating the density correction data D for the target pixel in the density correction value generation unit 26 is described in detail.

The pixels (1-1 to 5-5) shown in FIG. 7A have 4-bit density values (density values expressed by 4-bit 16 gradations (0 to 15)). The density correction value generation unit 26 first multiplies the density value each corresponding to all 24 pixels (surrounding pixels) except for the target pixel 52 with the pixel ratio shown in FIG. 7A (0.3 to 1.0: correction coefficients) and then adds the multiplied values. These ratios (0.3 to 1.0) are set in advance, and stored in the density correction value generation unit 26. It should be noted that “add” refers to adding up the values obtained by multiplying the destiny value each corresponding to all of the 24 pixels except for the target pixel 52 with the corresponding pixel ratio (0.3 to 1.0: correction coefficients) shown in FIG. 7A. Also, 4-bit data indicating the density values of all 24 pixels (surrounding pixels) except for the target pixel 52 are included in the image data G of pixels that is received from the image sending DMA unit 25 and stored in the line memories.

As is clear from FIG. 7A, as there are more dots with high density in positions closer to the target pixel 52, the result of the addition increases, and as the expansion of the laser beam is superposed on adjacent pixels, the toner affixing amount increases more than in the case where a plurality of pixels are formed on distant positions, and thus the printing density tends to increase.

Next, as shown in FIG. 7B, the density correction value generation unit 26 determines, based on the result of addition, a correction coefficient (second correction coefficient) that is set in advance. It should be noted that the correction coefficient (second correction coefficient) according to the result of the addition shown in FIG. 7B is determined experimentally using the print engine control CPU 5 and the density sensors 42a through 42c for detecting the influence of the surrounding pixels on the printing density of the target pixel, and the correction coefficient (second correction coefficient) according to the result of this addition is set (stored) in the density correction value generation unit 26 via the image processing CPU 21 from the print engine control CPU 5.

Also, the density correction value generation unit 26 determines a correction coefficient (first correction coefficient) corresponding to a printing position of the target pixel in the main scanning direction based on the correction coefficient (first correction coefficient) for each position in the main scanning direction shown in FIG. 7C. FIG. 7C shows the correction coefficient (first correction coefficient) for each printing position in the main scanning direction, which is determined based on the values output by the density sensors 42a through 42c measured in advance under a given image formation condition, and this correction coefficient (first correction coefficient) for each printing position in the main scanning direction is stored in a RAM or the like in the density correction value generation unit 26 via the image processing CPU 21 from the print engine control CPU 5. In other words, since the correction coefficient (correction amount) is determined by measuring a change (characteristics) in the density unevenness with the density sensors 42a through 42c, it is possible to handle the case the density unevenness in the main scanning direction changes over time.

The correction coefficient (first correction coefficient) in FIG. 7C is the amount of correction that serves as a base (base correction amount), and the correction coefficient (second correction coefficient) in FIG. 7B is a correction value for secondary correction of the base correction amount depending on the state of the pixels surrounding the target pixel 52.

The density correction value generation unit 26 outputs a result of multiplying of the correction coefficient in FIG. 7C and the correction coefficient in FIG. 7B as the correction value (density correction value).

For example, if the conversion lookup table (LUT) 271 shown in FIGS. 5A and 5B is used in the pulse width modulation unit 27, then the density correction value generation unit 26 substitutes the product (m) of the correction coefficient in FIG. 7C and the correction coefficient in FIG. 7B into the following equation, and determines a correction value (density correction value). It should be noted that this is merely an example and the amount of correction may be determined only by the product of the correction coefficient in FIG. 7C and the correction coefficient in FIG. 7B.

15×(m+1)/2 Equation

If the value obtained by substituting the product (m) into the above equation is equal to or less than 15, a value (0 to 15) whose decimal places are rounded off is taken as the correction value (density correction value), and this correction value (density correction value) is converted into the 4-bit density correction data D and output to the pulse width modulation unit 27. On the other hand, if the value obtained by substituting the product (m) in the above equation is greater than 15, “15” is taken as the correction value (density correction value), and this correction value (density correction value) is converted into the 4-bit density correction data D and output to the pulse width modulation unit 27.

As a specific example, for example, if the correction coefficient (first correction coefficient corresponding to the position of the target pixel) in FIG. 7C serving as a reference is −0.5, and the correction coefficient (second correction coefficient determined based on the result obtained by multiplying density value each corresponding to the plurality of surrounding pixels (surrounding pixels) except for the target pixel with ratio (correction coefficient) set in advance and adding the obtained products) in FIG. 7B is 1.0, since the target pixel 52 is printed independently (printed without being superposed on adjacent pixels), printing is performed with a coefficient of −0.5 (equal to −0.5×1.0). If the conversion lookup table (LUT) 271 shown in FIGS. 5A and 5B is used, then the product (m) of −0.5 is substituted into the above equation, a value of “4” is determined as the correction value (density correction value) of the target pixel 52, and density correction data D indicating this value is sent to the pulse width modulation unit 27. As a result, the pulse width of the formed pulse signal becomes thin, which serves to keep the density low.

On the other hand, if the correction coefficient in FIG. 7C is −0.5, and the correction coefficient in FIG. 7B is 0.2, then printing is performed with a correction coefficient of −0.1. If the conversion lookup table (LUT) 271 shown in FIGS. 5A and 5B is used, then the product (m) of −0.1 is substituted into the above equation, a value of “7” is determined as the correction value (density correction value) of the target pixel 52, and density correction data D indicating this value is sent to the pulse width modulation unit 27. As a result, the pulse width of the pulse signal becomes slightly thinner, which serves to slightly lower the density.

Also, if the correction coefficient in FIG. 7C is +0.5, and the correction coefficient in FIG. 7B is 1.0, then printing is performed with a correction coefficient of +0.5 (equal to +0.5×1.0). If the conversion lookup table (LUT) 271 shown in FIGS. 5A and 5B is used, then the product (m) of +0.5 is substituted into the above equation, a value of “11” is determined as the correction value (density correction value) of the target pixel 52, and density correction data D indicating this value is sent to the pulse width modulation unit 27. As a result, the pulse width expands, which serves to increase the density.

On the other hand, if the correction coefficient in FIG. 7C is +0.5, and the correction coefficient in FIG. 7B is 0.3, then printing is performed with a correction coefficient of +0.15. If the conversion lookup table (LUT) 271 shown in FIGS. 5A and 5B is used, then the product (m) of +0.15 is substituted into the above equation, a value of “9” is determined as the correction value (density correction value) of the target pixel 52, and density correction data D indicating this value is sent to the pulse width modulation unit 27. As a result, the pulse width of a signal becomes slightly thicker, which serves to slightly increase the density.

According to this method for calculating density correction data, depending on the density of the pixels to be formed, even if the relationship between the pulse width and the image density is non-linear (if the pulse width is not proportional to the actual printing density), it is possible to accurately correct density unevenness in the main scanning direction.

It should be noted that in the present embodiment, although three points in the main scanning direction are measured by arranging three density sensors 42a through 42c, more points may be measured by arranging more density sensors, or the amount of correction may be determined by estimating the amount of correction for points (positions) in the main scanning direction with fewer measurement points.

The present invention can be embodied in other forms without departing from the spirit or essential characteristics thereof. The foregoing embodiments are therefore to be considered in all respects as illustrative and not restrictive. The scope of the invention is indicated by the appended claims rather than by the foregoing description. Furthermore, all modifications and changes that come within the meaning and range of equivalency of the claims are intended to be embraced therein.

### DESCRIPTION OF REFERENCE NUMERALS

1 Scanner unit
2 Image processing unit
3 laser scanning unit (LSU)
4 Print engine (image forming unit)
5 Print engine control CPU
6 Communication line
7 Pulse signal transfer line
8 Communication line
11 Original placement stage
12 Original
13 Lamp unit
14-16 Mirror
17 Lens unit
18 CCD sensor
19 Document feeder unit
21 Image processing CPU
22 Image processing circuit
23 Bus
24 Image memory
25 Image sending DMA unit
26 Density correction value generation unit
27 Pulse width modulation unit
31 Laser driver
32 BD sensor
33 Laser diode (LD)
34 Reference voltage source
35 APC timing generation circuit
36 Polygon mirror
37 Fθ lens
38 Reflecting mirror
39 BD sensor mirror
40 Fixing unit
41 Photosensitive body
42a-42c Density sensor
43 Paper cassette
45 Development unit
46 Cleaning unit
47 Charger
60 Discharge tray

What is claimed is:

1. An image forming apparatus comprising:
a pulse width modulation unit that changes a pulse width of a signal in accordance with image data; and
an image forming unit that forms an image by driving a laser beam with a signal whose pulse width has been modulated by the pulse width modulation unit and scanning a photosensitive body,
wherein the pulse width of the signal output by the pulse width modulation unit is corrected in accordance with a density unevenness characteristics in a main scanning direction of the image forming unit.

2. The image forming apparatus according to claim 1, wherein the pulse width modulation unit synchronizes data that indicates an amount of correction according to the density unevenness characteristics in the main scanning direction with the image data, and receives that data along with the image data.

3. The image forming apparatus according to claim 1, wherein the correction of the pulse width by the pulse width modulation unit is performed by changing the pulse width toward both sides in the main scanning direction from a center of a pixel.

4. The image forming apparatus according to claim 1, wherein the correction amount of the pulse width by the pulse width modulation unit is determined based on a result obtained by measuring a density of the image formed by the image forming unit.

5. The image forming apparatus according to claim 4, wherein the correction amount of the pulse width is determined based on a first correction coefficient for each position in the main scanning direction that is determined in advance based on a value that has been measured under a given image formation condition and output by a density detection unit.

6. The image forming apparatus according to claim 4, wherein the correction amount of the pulse width is determined by a status of a plurality of pixels surrounding a target pixel in the image data.

7. The image forming apparatus according to claim 6, wherein the correction amount of the pulse width of the target pixel is determined based on a value found by determining a first correction coefficient corresponding to the position of the target pixel based on the first correction coefficient for each respective position in the main scanning direction that is determined in advance based on a value that has been measured under a given image formation condition and output by a density detection unit, determining a second correction coefficient based on a result obtained by multiplying a density value each corresponding to the plurality of surrounding pixels except for the target pixel with a correction coefficient set in advance and adding the multiplied values, and multiplying the first correction coefficient corresponding to the position of the target pixel with the second correction coefficient.
